(19) United States
(12) Patent Application Publication
(10) Pub. No.: US 2010/0296013 A1
(43) Pub. Date: Nov. 25, 2010

(54) PANEL

(76) Inventors: Chao-Yu Hung, Kaohsiung County (TW); Wei-Hung Tsay, Taichung County (TW)

Correspondence Address: NORTH AMERICA INTELLECTUAL PROPERTY CORPORATION, P.O. BOX 506, MERRIFIELD, VA, 22116, US

(21) Appl. No.: 12/782,696

(22) Filed: May 18, 2010

Related U.S. Application Data
(60) Provisional application No. 61/186,180, filed on Jun. 11, 2009.

(30) Foreign Application Priority Data
May 25, 2009 (TW) 098117242

(51) Int. Cl. G02F 1/1343

(52) U.S. Cl. 349/33

(57) ABSTRACT

A panel is disclosed in the present invention. The panel includes at least a liquid crystal layer, at least a first electrode layer, at least a second electrode layer and at least two control electrodes. The liquid crystal layer includes a plurality of liquid crystal molecules. The first electrode layer is disposed in a first direction with respect to the liquid crystal layer. The first electrode layer includes a plurality of etching structures and a plurality of conducting structures. The second electrode layer is also disposed in the first direction with respect to the liquid crystal layer. The two control electrodes are disposed in a second direction with respect to the liquid crystal layer. The two control electrodes are utilized to generate an electric field substantially distributing along the second direction to control operations of the plurality of liquid crystal molecules.

### CROSS REFERENCE TO RELATED APPLICATIONS

This application claims the benefit of the filing date of U.S. provisional patent application No. 61/186180, filed Jun. 11,2009, the contents of which are hereby incorporated by reference.

### BACKGROUND OF THE INVENTION

1. Field of the Invention

The present invention relates to a panel, and more particularly, to a display panel for reducing response time of liquid crystal molecules.

2. Description of the Prior Art

In general, a panel includes at least one liquid crystal layer, a pair of alignment layers, a pair of electrodes and a pair of glass substrates. A top electrode layer is coated on the top glass substrate and an alignment layer is deposited or printed on the electrode layer; and a bottom electrode layer is coated on the bottom glass substrate with alignment layer deposited on it. The liquid crystal layer is sandwiched by the two side substrates with a plurality of liquid crystal molecules in it.

When the panel is operated, the driving circuits of the panel apply voltages to the top electrode layer and the bottom electrode layer to power on the top electrode layer and the bottom electrode layer, and an electric field is therefore produced. Subsequently, the liquid crystal molecules in the liquid crystal layer rotate to align with the direction of the electric field in parallel. When the applied voltages of the driving circuits in the panel are moved out from the top electrode layer and the bottom electrode layer, the electric field between the top electrode layer and the bottom electrode layer will disappear and the liquid crystal molecules will rotate back to the original positions. By this method, light beams passing through the liquid crystal molecules can be controlled for displaying.

However, when the electric field is disappeared, the recovery rate of the liquid crystal molecules is not fast enough. This results in problems such as slow response time and poor display quality.

### SUMMARY OF THE INVENTION

It is therefore one of the objectives of the present invention to provide a panel for reducing response time of liquid crystal molecules.

According to a preferred embodiment of the present invention, a panel is provided. The panel includes at least a liquid crystal layer, at least a first electrode layer, at least a second electrode layer, and at least two control electrodes. The liquid crystal layer also includes a plurality of liquid crystal molecules. The first electrode layer is disposed in a first direction with respect to the liquid crystal layer, and the first electrode layer includes a plurality of etching structures and a plurality of conducting structures. The second electrode layer is disposed in the first direction with respect to the liquid crystal layer. The two control electrodes are disposed in a second direction with respect to the liquid crystal layer, and the two control electrodes are configured to generate an electric field substantially distributing along the second direction to control operations of the plurality of liquid crystal molecules.

According to another preferred embodiment of the present invention, a panel is provided. The panel includes at least a liquid crystal layer, at least a first electrode layer, and at least a second electrode layer. The liquid crystal layer includes a plurality of liquid crystal molecules. The first electrode layer is disposed on one side of the liquid crystal layer, and the first electrode layer includes a plurality of etching structures and a plurality of conducting structures. The second electrode layer is disposed on another side of the liquid crystal layer, and at least two control electrodes are disposed on a surface of the second electrode layer corresponding to the liquid crystal layer. An electric field is generated by powering on the control electrodes, and the liquid crystal molecules are arranged according to a direction of the electric field.

According to another preferred embodiment of the present invention, a panel is provided. The panel includes at least a liquid crystal layer, at least a first electrode layer, and at least a second electrode layer. The liquid crystal layer includes a plurality of liquid crystal molecules. The first electrode layer is disposed on one side of the liquid crystal layer, and the first electrode layer includes at least an etching structure and a plurality of conducting structures. The two control electrodes are disposed on the first electrode layer corresponding to the side of the liquid crystal layer. The second electrode layer is disposed on another side of the liquid crystal layer. An electric field is generated by powering on the control electrodes, and the liquid crystal molecules are arranged according to a direction of the electric field.

In the panel of each embodiment of the present invention, when the first electrode layer and the second electrode layer are powered off, at least two control electrodes are powered on to generate a second electric field. Accordingly, the liquid crystal molecules can be actively forced back to the original positions, and the response time of the liquid crystal molecules and display quality can be improved.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1A is a schematic diagram illustrating a panel according to a preferred embodiment of the present invention.

FIG. 1B is a schematic diagram illustrating an operation state of the panel in FIG. 1A.

FIG. 1C is a schematic diagram illustrating another operation state of the panel in FIG. 1A.

FIG. 2A is a schematic diagram illustrating a panel according to another preferred embodiment of the present invention.

FIG. 2B is a top view of the panel in FIG. 2A.

FIG. 3 is a schematic diagram illustrating a panel according to still another preferred embodiment of the present invention.

FIG. 4 is a schematic diagram illustrating a panel according to yet another preferred embodiment of the present invention.

FIG. 5 is a schematic diagram illustrating a panel with more than one liquid crystal layer according to a preferred embodiment of the present invention.

FIG. 6 is a schematic diagram illustrating a panel with more than one liquid crystal layer according to another preferred embodiment of the present invention.

### DETAILED DESCRIPTION

Panels with fast response time of preferred embodiments of the present invention are illustrated in details with accompanying drawings. It should be noted that the panel may be applicable to a three-dimensional panel, a two-dimensional panel, or a liquid crystal lens.

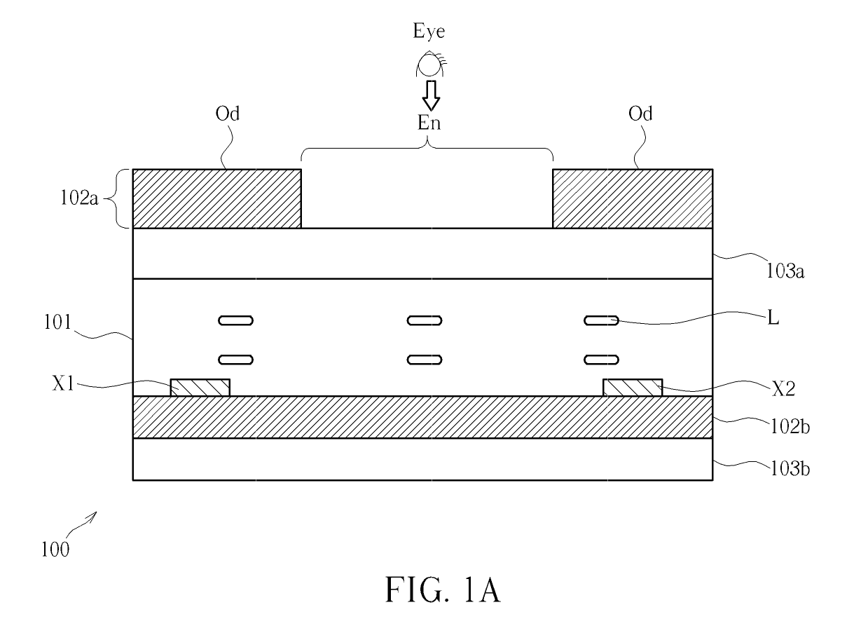

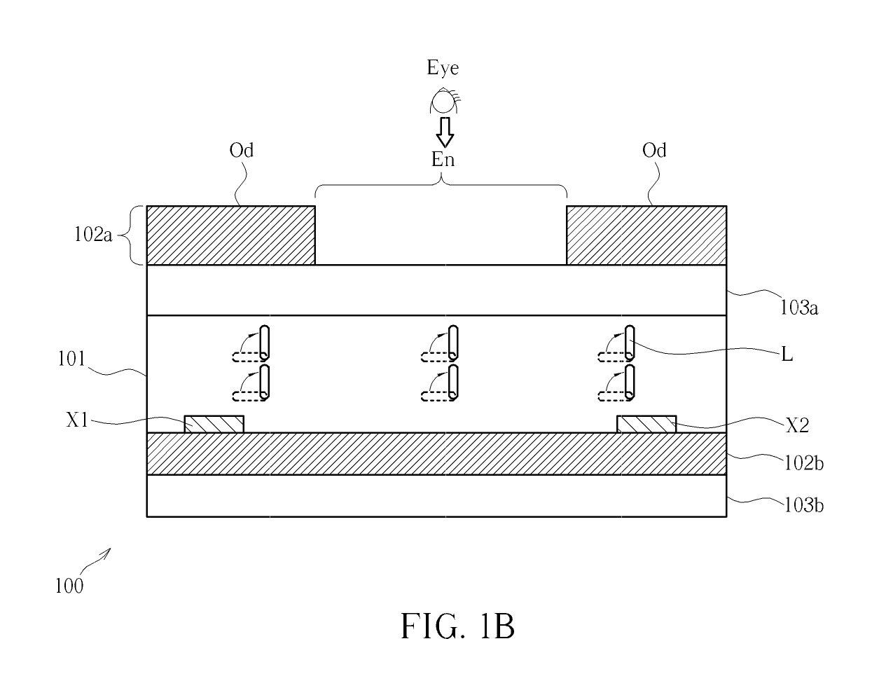

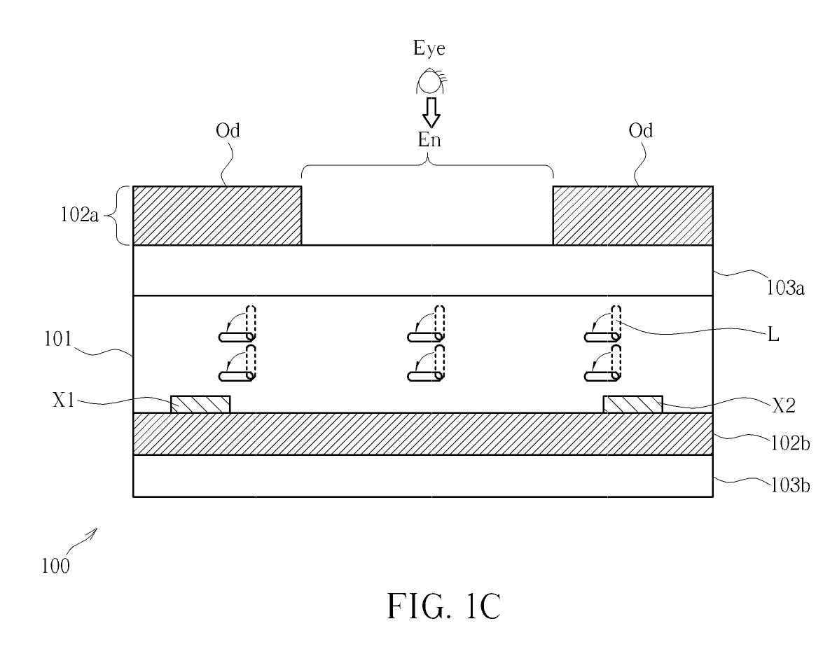

FIG. 1A is a schematic diagram illustrating a panel 100 according to a preferred embodiment of the present invention. The panel 100 includes at least a liquid crystal layer 101, at least a first electrode layer 102a, at least a second electrode layer 102b, and at least two control electrodes X1, X2. The liquid crystal layer 101 includes a plurality of liquid crystal molecules L. The first electrode layer 102a is disposed in a first direction with respect to the liquid crystal layer 101 (e.g. disposed on one side of the liquid crystal layer 101), and the first electrode layer 102a includes a plurality of etching structures En and a plurality of conducting structures Od. The etching structure En can be a hole or a trench. Also, a hole or a trench may be further disposed in the conducting structure Od. It should be noted that only an etching structures En is drawn in the figure for simplifying the description. A designer may also put single etching structures En into practice according to different requirement. The second electrode layer 102b is also disposed in the first direction with respect to the liquid crystal layer 101 (e.g. disposed on the opposite side of the liquid crystal layer 101), and the two control electrodes X1 , X2 are disposed in a second direction with respect to the liquid crystal layer 101. In one preferred embodiment, the two control electrodes X1, X2 may be disposed on a surface of the second electrode layer 102b corresponding to the liquid crystal layer 101 as shown in FIG. 1A.

In the panel 100 of the preferred embodiment of the present invention, the etching structures En and the conducting structures Od of the first electrode layer 102a are operated cooperatively with other layers to form different media in the liquid crystal layer 101. Accordingly, the panel 100 has a plurality of refractive indexes corresponding to the different media, and which can therefore implement three-dimensional display effect. For example, when the first electrode layer 102a and the second electrode layer 102b are powered on, a region of the liquid crystal layer 101 between the etching structures En of the first electrode layer 102a and the second electrode layer 102b has a first refractive index; a region of the liquid crystal layer 101 between the conducting structures Od of the first electrode layer 102a and the second electrode layer 102b has a second refractive index. The three-dimensional operation and structure of the panel can refer to another patent application, Taiwan patent application No. 097146707, also filed by our company, Tunable Optix Corporation. In order to focus on the contents of the present invention, detail descriptions are not redundantly given.

It should be noted that, in the present preferred embodiment, a pair of glass substrates 103a and 103b are disposed on two opposite sides of the liquid crystal layer 101. In another preferred embodiment, at least a pair of alignment layer (also referred to as rubbing layers) (not shown in the figure), at least a pair of polarization layers (not shown in the figure), or other components that are currently existing or proposed in the future may be disposed on sides of the liquid crystal layer 101 based on the designer's discretion. Furthermore, only a part or all of the aforementioned components may be disposed on the sides of the liquid crystal layer 101, and the location of each component may be chosen based on the designer's discretion. The related setting methods and skills should be understood by those of ordinary skill in the art and are not redundantly described.

Please refer to FIGS. 1A, 1B, and 1C, which illustrate the operation method and principle of the panel 100 with fast response time according to the preferred embodiment of the present invention. It should be noted that the arrangements of the liquid crystal molecules L are irregular when electrode layers or electrodes of the panel 100 are powered off. However, for the convenience of illustration, liquid crystal molecules L of the liquid crystal layer 101 are drawn in an orderly manner.

First, when the panel 100 is operated, inner circuits (not shown in the figure) of the panel 100 drive the first electrode layer 102a and the second electrode layer 102b by applying predetermined voltages to the first electrode layer 102a and the second electrode layer 102b. Accordingly, the first electrode layer 102a and the second electrode layer 102b are powered on, and a first electric field with a predetermined intensity in a first direction is generated between the first electrode layer 102a and the second electrode layer 102b. Subsequently, the liquid crystal molecules L in the liquid crystal layer 101 rotate to be arranged in the first direction (such as a substantially vertical direction) of the first electric field, exhibiting a standing state as shown in FIG. 1B. At this time, the direction of refraction of light beams is altered by the rotation of the liquid crystal molecules L. For example, the light beams can pass through the panel 100 and reach the eyes of viewers.

When the position (or rotating angle) of the liquid crystal molecules L is required to be recover, the voltage difference between the first electrode layer 102a and the second electrode layer 102b is turned off by the inner circuits of the panel 100 (i.e. the first electrode layer 102a and/or the second electrode layer 102b are powered off), and the two control electrodes X1, X2 on the surface of the second electrode layer 102b are driven by applying predetermined voltages to the two control electrodes X1, X2. Accordingly, a second electric field with a predetermined intensity in a second direction is generated between the control electrode X1 and the control electrode X2. Subsequently, the liquid crystal molecules L in the liquid crystal layer 101 rotate to be arranged in the second direction (such as a substantially horizontal direction) of the second electric field, showing a lying state (also referred to as flat state) as illustrated in FIG. 1C. At this time, the direction of refraction of light beams can be altered by the rotation (distribution) of the liquid crystal molecules L. For example, the panel can be a normally white panel or a normally black panel.

It should be noted that, in the panel 100 of the preferred embodiment of the present invention, when the first electrode layer 102a and the second electrode layer 102b are powered off, the two control electrodes X1 , X2 are additionally utilized to generate the second electric field, which actively forces the liquid crystal molecules L back to the aforementioned second direction. Consequently, the response time of the liquid crystal molecules L in the panel 100 can be reduced, the display quality of the panel 100 can be improved, and the problems in the prior art can be therefore resolved.

There will be a dielectric layer (not shown in the drawing) between the control electrodes X1 , X2 and the second electrode layer 102b. The control electrodes X1 , X2 and the second electrode layer 102b are controlled independently and separately (not shown in the figure).

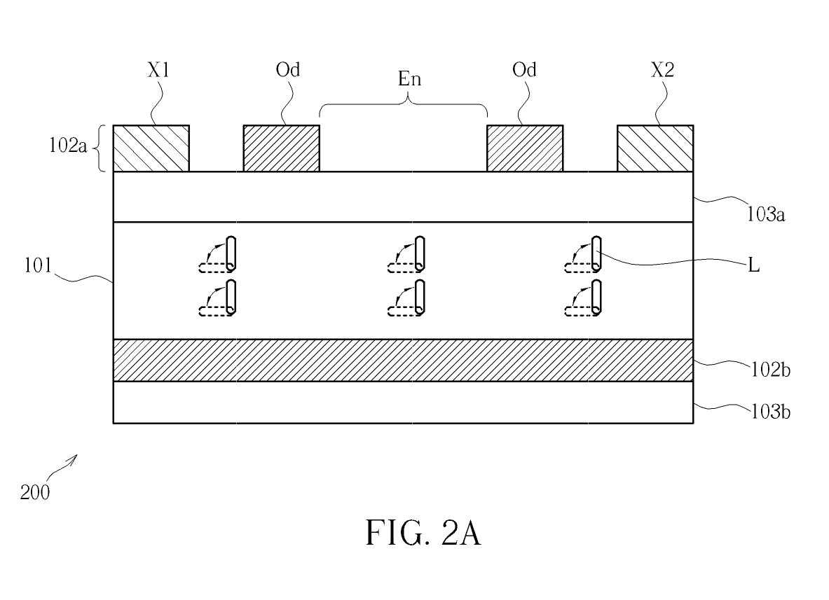

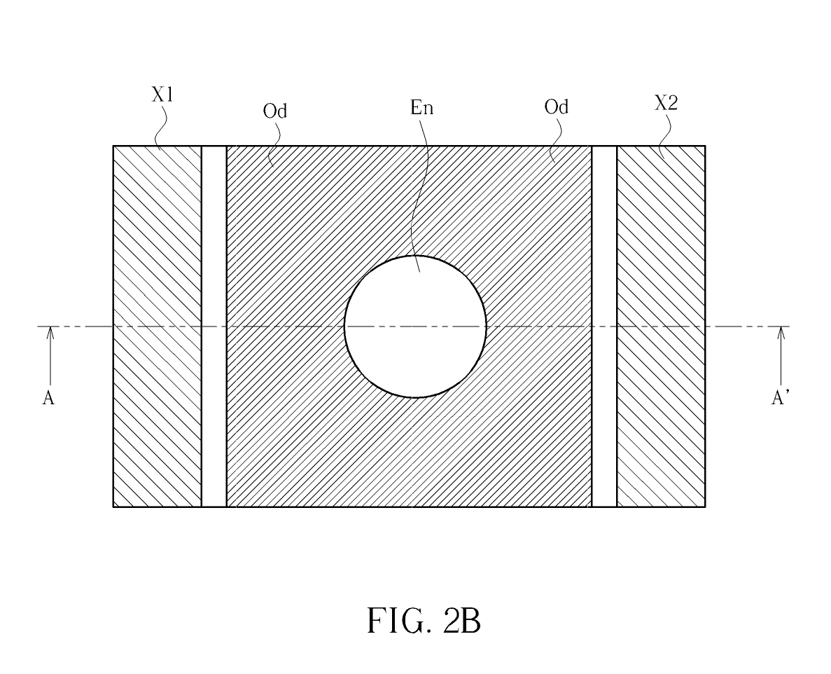

FIG. 2A is a schematic diagram illustrating a panel 200 according to another preferred embodiment of the present invention. The panel 200 includes at least a liquid crystal layer 101, at least a first electrode layer 102a, at least a second electrode layer 102b, and at least two control electrodes X1, X2. The structure and operation method of the panel 200 is substantially the same with that of the panel 100. The difference between the panel 200 and the panel 100 is that the control electrodes X1, X2 of the panel 200 are disposed on the first electrode layer 102a corresponding to the side of the liquid crystal layer 101, that is the control electrodes X1, X2 and the first electrode layer 102a are in the same side, and separated by a thin dielectric layer (not shown). When the panel 200 is operated, inner circuits (not shown in the figure) of the panel 200 apply voltages to the conducting structures Od of the first electrode layer 102a and the second electrode layer 102b, and thus a first electric field with a predetermined intensity in a first direction is generated between the first electrode layer 102a and the second electrode layer 102b. For example, the first direction is a substantially vertical direction, and the liquid crystal molecules L are in a standing state as shown in the figure. When the liquid crystal molecules L are to be returned to the original positions, the voltage difference between the conducting structures Od of the first electrode layer 102a and the second electrode layer 102b is removed by the inner circuits (not shown in the figure) of the panel 200. Also, a voltage difference is applied between the two control electrodes X1, X2 to generate a second electric field with a predetermined intensity in a second direction. For example, the second direction is a substantially horizontal direction, and the liquid crystal molecules L are in a lying state (also referred to as flat state) as shown in the figure.

By this method, the response time of the liquid crystal molecules L in the panel 200 can be reduced and the display quality of the panel 200 can be improved, so that the problems in the prior art can also be resolved. In addition, the number of masks required in fabrication processes can be reduced due to the structure of this embodiment of the present invention. Therefore, the productivity can be increased, and the manufacturing cost can be decreased. FIG. 2B is a top view of the panel 200 in FIG. 2A, and FIG. 2A is a cross-sectional view of FIG. 2B taken along a line A-A′. The configurations of the control electrodes X1, X2, the conducting structures Od, and etching structures En can be clearly understood as shown in FIG. 2B.

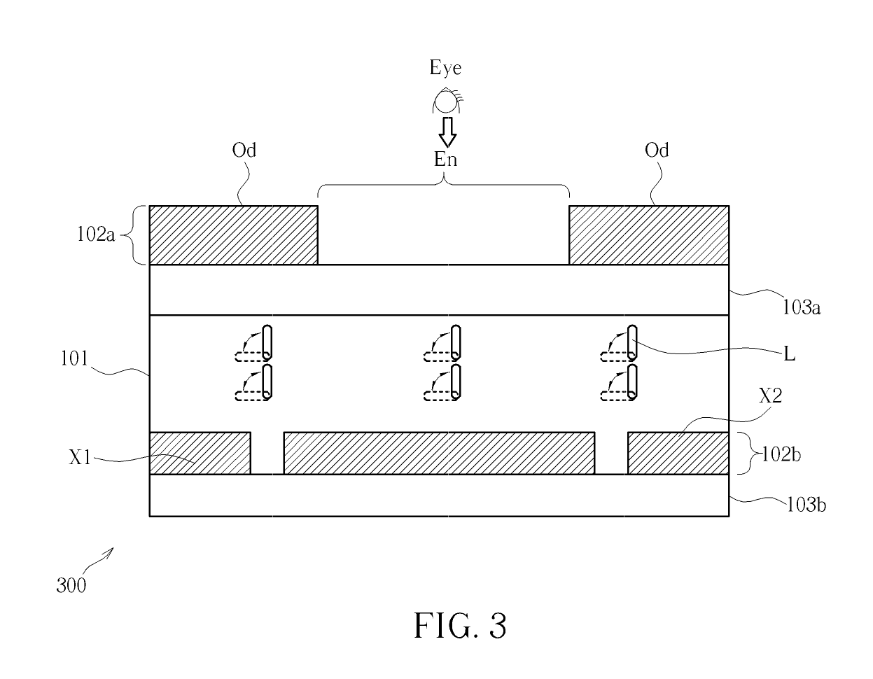

FIG. 3 is a schematic diagram illustrating a panel 300 according to still another preferred embodiment of the present invention. The panel 300 includes at least a liquid crystal layer 101, at least a first electrode layer 102a, at least a second electrode layer 102b, and at least two control electrodes X1, X2. The structure and operation method of the panel 300 is substantially the same with that of the panel 100. The difference between the panel 300 and the panel 100 is that the control electrodes X1, X2 of the panel 300 are formed by dividing the second electrode layer 102b. When the panel 300 is operated, inner circuits (not shown in the figure) of the panel 300 apply voltages to the conducting structures Od of the first electrode layer 102a and a part of the second electrode layer 102b, wherein the part of the second electrode layer 102b does not include the control electrodes X1 , X2. Accordingly, a first electric field with a predetermined intensity in a first direction is generated. For example, the first direction is a substantially vertical direction, and the liquid crystal molecules L are in a standing state as shown in the figure. When the liquid crystal molecules L are to be returned to the original positions, the conducting structures Od of the first electrode layer 102a and the part of the second electrode layer 102b are powered off by the inner circuits (not shown in the figure) of the panel 300. Also, the two control electrodes X1, X2 are powered on to generate a second electric field with a predetermined intensity in a second direction. For example, the second direction is a substantially horizontal direction, and the liquid crystal molecules L are in a lying/flat state as shown in the figure.

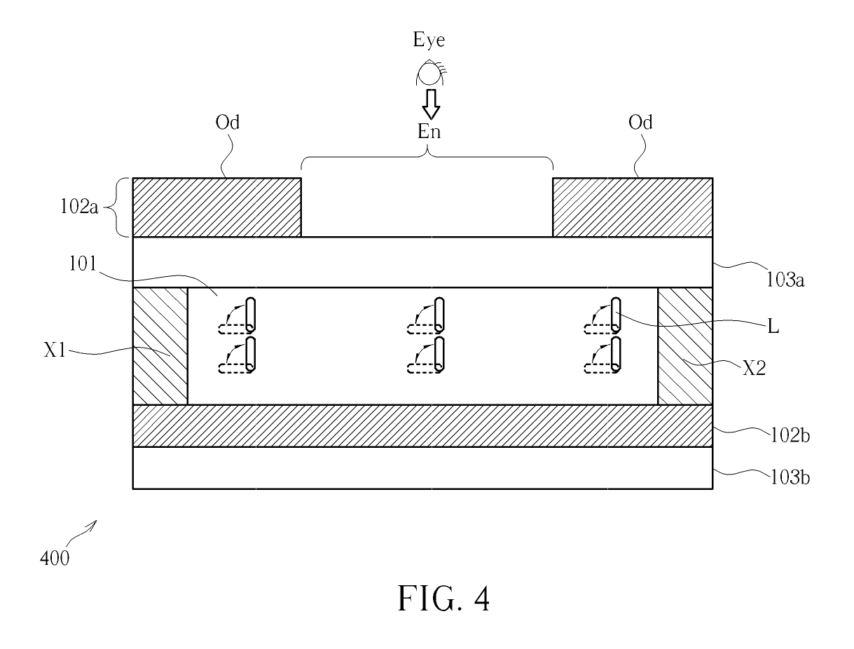

The present invention can be implemented in any kinds of methods. Any controlling method that uses an electric field of another direction to force the liquid crystal molecules L back to the original positions falls into the spirit and scope of the present invention. As shown in FIG. 4, the panel 400 includes at least a liquid crystal layer 101, at least a first electrode layer 102a, at least a second electrode layer 102b, and at least two control electrodes X1, X2. The structure and operation method of the panel 400 is substantially the same with that of the panel 100. The difference between the panel 400 and the panel 100 is that the control electrodes X1, X2 of the panel 400 are disposed on two opposite sides inside the liquid crystal layer 101. Those of ordinary skill in the art should understand the operation method according to the aforementioned description, and repeated descriptions are not redundantly given.

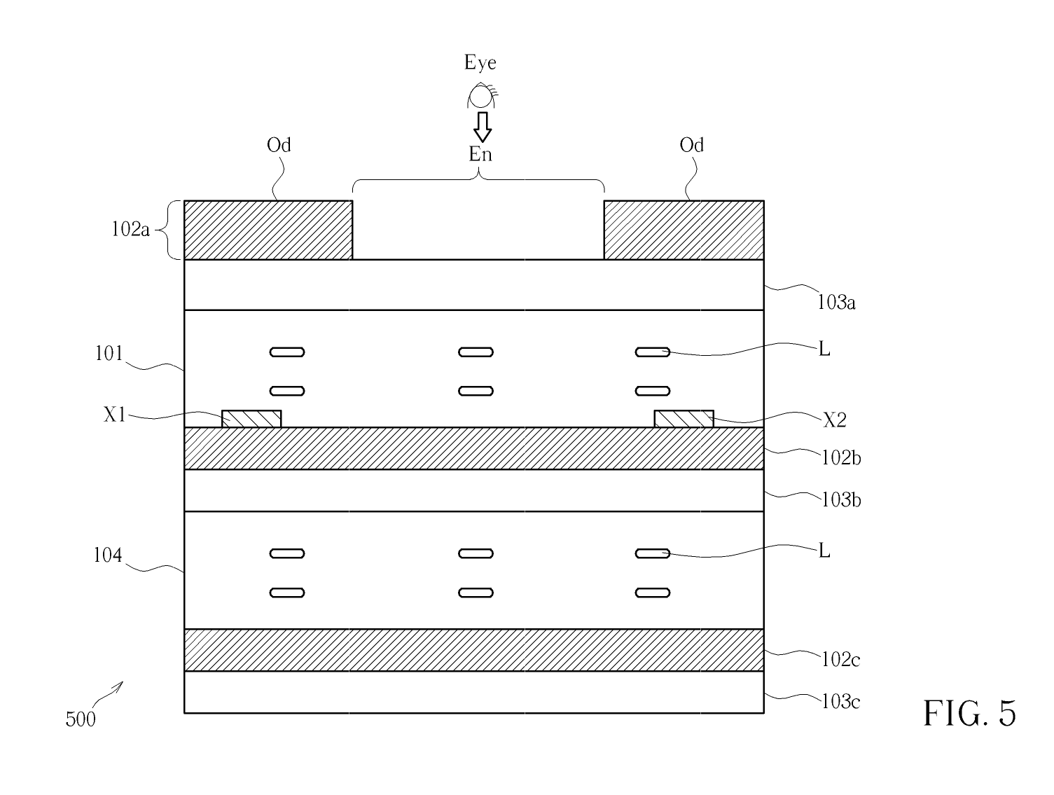

In addition, the panel of the present invention may include more than one liquid crystal layer. Please refer to FIG. 5, which illustrates a panel with more than one liquid crystal layer cording to a preferred embodiment of the present invention. As shown in FIG. 5, the panel 500 includes two liquid crystal layers 101 and 104. The liquid crystal layer 101 is sandwiched by two glass substrates 103a and 103b, and the liquid crystal layer 104 is sandwiched by two glass substrates 103b and 103c. In this embodiment, the panel 500 further includes at least a first electrode layer 102a, at least a second electrode layer 102b, at least a third electrode layer 102c, and at least two control electrodes X1, X2. An electric field in a substantially vertical direction could be generated by the voltage difference between the first electrode layer 102a and the second electrode layer 102b to control the liquid crystal molecules L in the liquid crystal layer 101, and another electric field in a substantially vertical direction could be generated by the voltage difference between the first electrode layer 102b and the second electrode layer 102c to control the liquid crystal molecules L in the liquid crystal layer 104.

It should be noted that the electrode layers could be on either side of glass substrates 103a, 103b, or 103c, while the alignment layers (not shown in the figure) must be next to and in contact with the liquid crystal layers 101 and 104 (so there will be 4 alignment layers in this embodiment). Also, each electrode layer could be with patterns (e.g. etching structure En and the conducting structure Od) or without patterns. Furthermore, the etching structure En and the conducting structure Od could be in either side of the glass substrates 103a, 103b, or 103c. Not necessary every side of the glass substrate will need the electrode layer. Then, the control electrodes X1 , X2 which will generate the horizontal electric field (reference to the electric field generated by the electrode layers) could be located at any side of the glass substrate, not necessary to co-exist with electrode layer which will generate the vertical electric field.

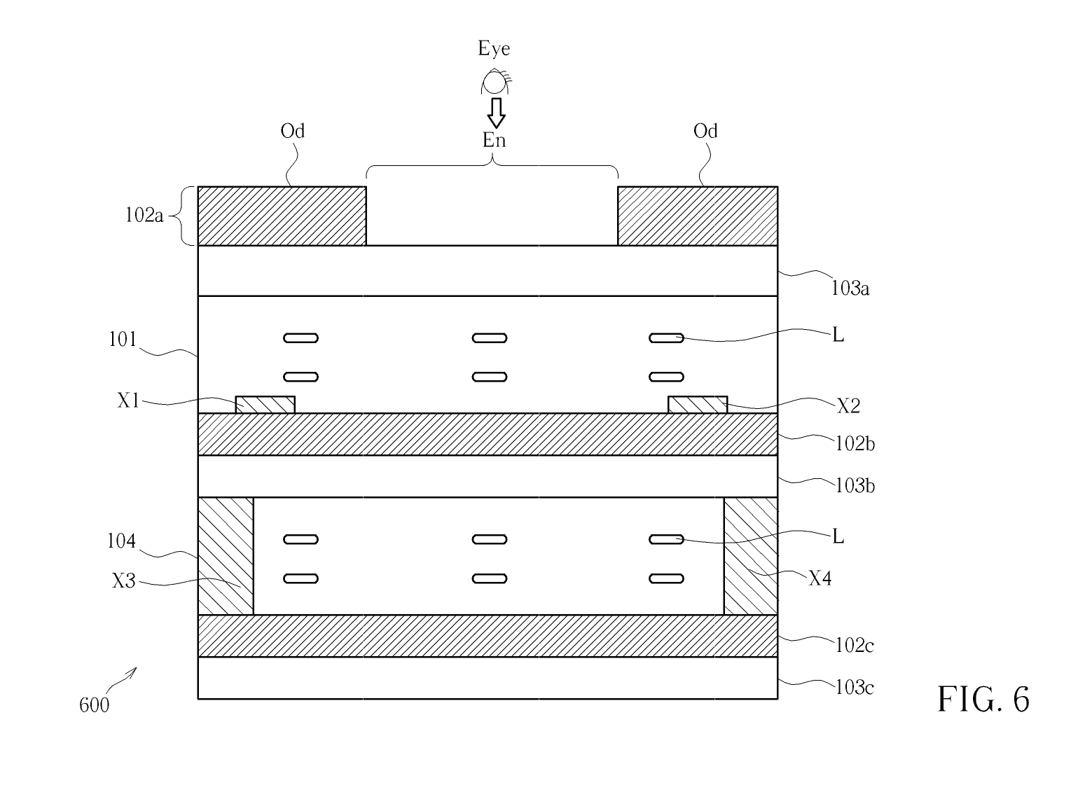

Moreover, the location of the control electrodes of the present invention is not limited to the aforementioned embodiment. Please refer to FIG. 6, which illustrates a panel with more than one liquid crystal layer according to another preferred embodiment of the present invention. Compared to the panel 500 shown in FIG. 5, the panel 600 shown in FIG. 6 further includes at least two control electrodes X3, X4. As a result, the liquid crystal molecules L in the liquid crystal layer 101 could be controlled by the control electrodes X1, X2, and the liquid crystal molecules L in the liquid crystal layer 104 could be controlled by the control electrodes X3, X4. In this embodiment, the arrangement of the control electrodes X3, X4 is different from that of the control electrodes X1, X2, but the arrangement of the control electrodes X3, X4 could be the same with that of the control electrodes X1, X2 in another embodiment. Besides, in the panel with more than one liquid crystal layer, the shape and arrangement of the control electrodes for one of the liquid crystal layers could be the same with that of FIG. 1A, FIG. 2A, FIG. 3, or FIG. 4. However, it is not limited herein and the shape and arrangement of the control electrodes could be any other suitable design.

Furthermore, the control electrodes of the present invention and a sealing frame for confining the liquid crystal molecules could be incorporated. As shown in FIG. 6, the control electrodes X3, X4 could be formed by two disconnected parts of the sealing frame. In other words, the sealing frame in this embodiment could be constituted by an electrically conductive material, and this electrically conductive sealing frame could be divided into at least two disconnected parts and serve as the control electrodes. When the control electrodes are powered on to produce a horizontal electric field, the liquid crystal molecules could be forced back to the previous state and the response time of the liquid crystal molecules could be reduced.

Since the structure and operation method of the panels 500 and 600 are similar to that of the panel 100, those of ordinary skill in the art should understand the operation method according to the aforementioned description, and repeated descriptions are not redundantly given.

It should be noted that the number of the control electrodes of the present invention is not limited to that in the aforementioned embodiment. The number of the control electrodes may be N, wherein N is equal to or more than 2, and is smaller than the infinity. Furthermore, the number of the liquid crystal molecules is not limited to the number shown in the figure, and may be decided based on practical requirement. Also, the shape of the control electrode is not limited to planar, and may be any possible shape such as rectangular, triangular, round, oval, or film-like. In addition, the materials, the controlling methods, and the treatments of the contact positions of the control electrodes and the electrode layers may be determined based on designer's discretion. For example, the materials of the control electrodes and the electrode layers may have different impedances, or an insulating material may be disposed on the contact positions between the control electrodes and the electrode layers to isolate the control electrodes from the electrode layers. In applications, each structure configuration in the aforementioned embodiments may be combined. For example, the first electrode layer 102a of FIG. 2A may be incorporated into the panel of FIG. 1A, FIG. 3, or FIG. 4. Moreover, the first direction and the second direction of the aforementioned electric fields are not limited to substantially vertical or horizontal. A degree (angle) of the first direction and a degree (angle) of the second direction are any predetermined angles between 0 and 360 degrees, and the degree of the first direction and the degree of the second direction are different.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A panel, comprising:
at least a liquid crystal layer, the liquid crystal layer comprising a plurality of liquid crystal molecules;
at least a first electrode layer, disposed in a first direction with respect to the liquid crystal layer, the first electrode layer comprising a plurality of etching structures and a plurality of conducting structures;
at least a second electrode layer, disposed in the first direction with respect to the liquid crystal layer; and
at least two control electrodes, disposed in a second direction with respect to the liquid crystal layer, the two control electrodes being configured to generate an electric field substantially distributing along the second direction to control operations of the plurality of liquid crystal molecules.

2. The panel of claim 1, wherein when the two control electrodes are powered on, and the first electrode layer and the second electrode layer are powered off.

3. The panel of claim 1, wherein when the two control electrodes are powered on, the electric field distributing along the second direction is generated and the plurality of liquid crystal molecules are arranged according to the second direction of the electric field.

4. The panel of claim 1, wherein when the first electrode layer and the second electrode layer are powered on, another electric field distributing along the first direction is generated and the plurality of liquid crystal molecules are arranged according to the first direction of the another electric field.

5. The panel of claim 1, wherein a region of the liquid crystal layer between the etching structures of the first electrode layer and the second electrode layer will provide the gradient refractive index effect when an electric voltage is applied on the first electrode layer and second electrode layer.

6. The panel of claim 1, wherein a degree of the first direction and a degree of the second direction are any predetermined angles between 0 and 360 degrees.

7. The panel of claim 6, wherein the degree of the first direction and the degree of the second direction are different.

8. The panel of claim 1, wherein the two control electrodes are respectively disposed on two opposite sides inside the liquid crystal layer.

9. The panel of claim 1, wherein the panel is applicable to a three-dimensional panel, a two-dimensional panel, or a liquid crystal lens.

10. The panel of claim 1, wherein the two control electrodes are formed by dividing the second electrode layer.

11. A panel, comprising:
at least a liquid crystal layer, the liquid crystal layer comprising a plurality of liquid crystal molecules;
at least a first electrode layer, disposed on one side of the liquid crystal layer, the first electrode layer comprising a plurality of etching structures and a plurality of conducting structures;
at least a second electrode layer, disposed on another side of the liquid crystal layer; and
at least two control electrodes disposed on a surface of the second electrode layer corresponding to the liquid crystal layer;
wherein the control electrodes are powered on to generate an electric field, and the plurality of liquid crystal molecules are arranged according to a direction of the electric field.

12. The panel of claim 11, wherein the direction of the electric field generated by the control electrodes is substantially horizontal.

13. The panel of claim 11, wherein when the two control electrodes are powered on, the first electrode layer and the second electrode layer are powered off.

14. The panel of claim 11, further comprising at least a pair of alignment layers and/or at least a pair of glass substrates disposed on sides of the liquid crystal layer.

15. The panel of claim 11, wherein the etching structures and the conducting structures of the first electrode layer are alternately arranged.

16. The panel of claim 15, wherein the etching structure is a hole or a trench.

17. The panel of claim 16, wherein a hole or a trench is further disposed in the conducting structure.

18. The panel of claim 11, wherein the panel is applicable to a three-dimensional panel, a two-dimensional panel, or a liquid crystal lens.

19. A panel, comprising:
at least a liquid crystal layer, the liquid crystal layer comprising a plurality of liquid crystal molecules;
at least a first electrode layer, disposed on one side of the liquid crystal layer, the first electrode layer comprising at least an etching structure and a plurality of conducting structures;
at least two control electrodes being disposed on the first electrode layer corresponding to the side of the liquid crystal layer; and
at least a second electrode layer, disposed on another side of the liquid crystal layer;
wherein the control electrodes are powered on to generate an electric field, and the plurality of liquid crystal molecules are arranged according to a direction of the electric field.

20. The panel of claim 19, wherein the direction of the electric field is substantially horizontal.

21. The panel of claim 19, wherein when the two control electrodes are powered on, the first electrode layer and/or the second electrode layer are powered off.

22. The panel of claim 19, wherein at least a pair of alignment layers and/or at least a pair of glass substrates are disposed on sides of the liquid crystal layer.

23. The panel of claim 19, wherein the etching structures and the conducting structures of the first electrode layer are alternately arranged.

24. The panel of claim 23, wherein the etching structure is a hole or a trench.

25. The panel of claim 24, wherein a hole or a trench is further disposed in the conducting structure.

26. The panel of claim 19, wherein the first electrode layer and the second electrode layer are powered on to form a plurality of refractive indexes in the liquid crystal layer.

27. The panel of claim 19, wherein the panel is applicable to a three-dimensional panel, a two-dimensional panel, or a liquid crystal lens.

28. A panel, comprising:
at least a liquid crystal layer, the liquid crystal layer comprising a plurality of liquid crystal molecules;
at least a first electrode layer, disposed in a vertical direction with respect to the liquid crystal layer, the first electrode layer comprising a plurality of etching structures and a plurality of conducting structures;
at least a second electrode layer, disposed in the vertical direction with respect to the liquid crystal layer; and
at least two control electrodes, disposed in a horizontal direction with respect to the liquid crystal layer;
wherein when the first electrode layer and the second electrode layer are powered on, a vertical electric field is generated between the first electrode layer and the second electrode layer to drive the plurality of liquid crystal molecules toward the vertical direction; when the two control electrodes are powered on, a horizontal electric field is generated between the two control electrodes to drive the plurality of liquid crystal molecules toward the horizontal direction.

29. The panel of claim 28 wherein an impedance of the two control electrodes is different from an impedance of any one of the first electrode layer and the second electrode layer.

30. The panel of claim 28 wherein the panel is applicable to a three-dimensional panel, a two-dimensional panel, or a liquid crystal lens.
